(19) United States
(12) Patent Application Publication
(10) Pub. No.: US 2014/0358967 A1
(43) Pub. Date: Dec. 4, 2014

(54) SERVICE SEARCH METHOD AND SERVER DEVICE IN DISTRIBUTED PROCESSING

(71) Applicant: FUJITSU LIMITED, Kawasaki-shi (JP)

(72) Inventors: Tetsu Yamamoto, Kawasaki (JP); Kazuya Kawashima, Fukuoka (JP)

(21) Appl. No.: 14/461,593

(22) Filed: Aug. 18, 2014

Related U.S. Application Data
(63) Continuation of application No. PCT/JP2012/058268, filed on Mar. 28, 2012.

(51) Int. Cl. G06F 17/30; H04L 29/06

(52) U.S. Cl. CPC G06F 17/30864; H04L 67/42
USPC 707/770

(57) ABSTRACT

A service search method, judges when receiving a service search request from a service search requester whether or not a local server matches a service search condition stored in the service search request by referring to the attribute about the local server; selects according to the route information a server having no search record in the search history information which is added to the service search request when it is judged that the local server does not match the service search condition, and transfers to the selected server the service search request to which the information about the local server is added as the search history information; and notifies the service search requester of a search request reply according to the route information generated by the local server when it is judged that the local server matches the service search condition.

### CROSS-REFERENCE TO RELATED APPLICATIONS

This application is a continuation of International Application No. PCT/JP2012/058268, filed on Mar. 28, 2012, and designated the U.S., the entire contents of which are incorporated herein by reference.

### FIELD

The embodiments discussed herein are related to a service search method, a program, and a server device in a distributed processing system.

### BACKGROUND

In a distributed processing system in which a plurality of servers are connected over a network, selecting one or more servers from among a plurality of servers executes a search when a service search request is issued from a client.

A prior art for executing such a search is described below. A client issues a request to a particular server, the particular server selects a server which meets the request by searching the states of other servers, and returns a reply to the client. In this case, the particular server inquires of the server which meets the request whether or not the request is acceptable, selects another server if the request is not acceptable, and continues inquiring until the request is accepted.

However, in the prior art, there is the problem that the load of the particular server which receives a search request becomes heavy when the number of the search requests from a client on a network increases.

To provide a service processing device and an associative processing system capable of efficiently performing associative processing by transmitting associative information with accuracy, another prior art sequentially transmits instructions for associative services among service processing devices which provide respective services. Thus, the services based on the instructions are sequentially executed by each service processing device, thereby performing associative processing for a series of services (for example, the patent document 1).

The transmitted instructions describe the attribute information for specification of the service processing device which performs each service. When transmitting the instruction to the next service processing device, a service processing device searches for a service processing device based on the attribute information for specification of a service processing device which performs the next service in the received instructions, and determines the destination. The service processing device transmits the instructions to the determined destination.

However, the prior art discloses the technology of the cooperation of a plurality of service processing devices based on the instructions, and the service processing devices are to cooperate with other devices while inquiring of a particular server which acts as a search server. Therefore, the prior art has also the problem that the load of the particular server becomes heavy.

### DOCUMENTS OF PRIOR ART

Patent Document 1: Japanese Laid-open Patent Publication No. 2005-228252

### SUMMARY

According to an aspect of the embodiment, a service search method using a plurality of servers which perform services: generates route information by switching the attribute information about a server with other servers; judges when receiving a service search request from a service search requester whether or not a local server matches a service search condition stored in the service search request by referring to the attribute about the local server; selects according to the route information a server having no search record in the search history information which is added to the service search request when it is judged that the local server does not match the service search condition, and transfers to the selected server the service search request to which the information about the local server is added as the search history information; and notifies the service search requester of a search request reply according to the route information generated by the local server when it is judged that the local server matches the service search condition.

With the above-mentioned configuration, it is not necessary to centrally search a particular node for a service search, thereby successfully distributing the load, and determining an appropriate service execution node during the search.

The object and advantages of the invention will be realized and attained by means of the elements and combinations particularly pointed out in the claims.

It is to be understood that both the foregoing general description and the following detailed description are exemplary and explanatory and are restrictive of the invention.

### BRIEF DESCRIPTION OF DRAWINGS

FIG. 1 is a configuration of a server node according to a present embodiment;

FIG. 2 is an explanatory view of the operation in the prior art;

FIG. 3 is an explanatory view of the operation of exchanging attribute information according to a present embodiment;

FIG. 4 is an example of a configuration of the data of a Hello message;

FIG. 5 is an example of a configuration of the data of an attribute information DB;

FIG. 6 is an example of a configuration of the data of a rout information DB;

FIG. 7 is an explanatory view of the operation of transferring a service search request message according to a present embodiment;

FIG. 8 is an example of a configuration of the data of a service search request message;

FIG. 9 is a flowchart of an example of an operation of controlling a search judging process;

FIG. 10 is a flowchart of an example of an operation of controlling a search result notifying process;

FIG. 11 is a flowchart of acquisition of an operation of controlling a search result transfer process;

FIG. 12 is a flowchart of an example of an operation of controlling a route information notifying process;

FIG. 13 is a flowchart of an example of an operation of controlling a route information generating process;

FIGS. 14A and 14B are an example of a data format of a Hello message;

FIGS. 15A and 15B are an example of a data format of a service search request message;

FIGS. 16A and 16B are an example of a data format of a search result message; and

FIG. 17 is a configuration of a hardware system which may realize the system according to a present embodiment.

### DESCRIPTION OF EMBODIMENTS

The modes for embodying the present invention are described below with reference to the attached drawings.

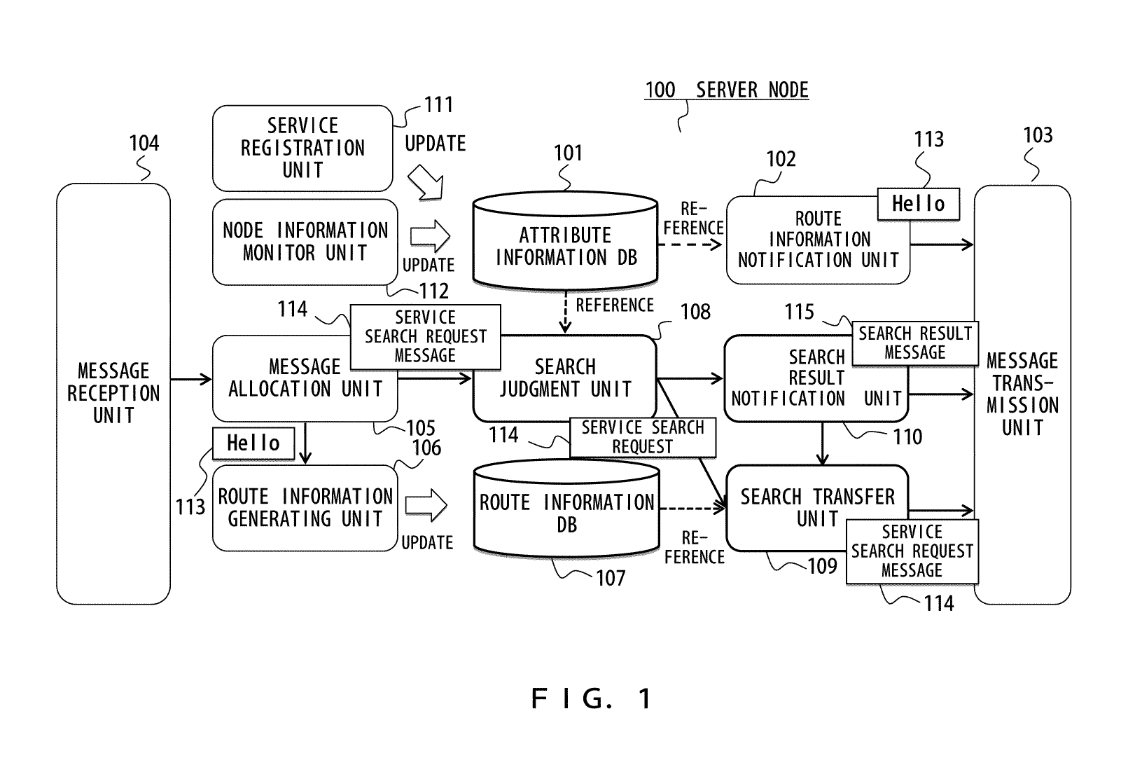

FIG. 1 is a configuration of a server node 100 as a server device which performs a service over a network in which a plurality of server devices are connected according to a present embodiment.

An attribute information database (hereafter referred to as an attribute information DB) 101 accumulates the attribute information including service information and resource information about a local server node 100.

A route information notification unit 102 generates, for example, a Hello message 113 including the service information and the resource information about the local server node 100 by periodically referring to the attribute information DB 101. Then, the route information notification unit 102 notifies other server nodes 100 which are connected to a network, for example, periodically of the Hello message 113 through a message transmission unit 103.

A message reception unit 104 receives messages from other server nodes 100. A message allocation unit 105 allocates the Hello message 113 to a route information generating unit 106 and a search request message 114 to a search judgment unit 108 in the messages received by the message reception unit 104.

The route information generating unit 106 generates route information according to the attribute information included in the Hello message 113 from other server nodes 100 received through the message reception unit 104 and the message allocation unit 105. In this case, for example, the route information generating unit 106 adds to the route information the priority of the service search calculated according to the attribute information. Then, the route information generating unit 106 updates route information database (hereafter referred to as a route information DB) 107 so that the generated route information may be included. That is, the route information DB 107 is a database which accumulates the route information generated by the route information generating unit 106 according to the attribute information exchanged among other server nodes 100.

Upon receipt of the service search request message 114 from a client node or other server node 100s through the message reception unit 104 and the message allocation unit 105, the search judgment unit 108 performs the following operation. The search judgment unit 108 judges whether or not the unit matches the service search condition stored in the service search request message 114 by referring to the attribute information about the unit which is stored in the attribute information DB 101. The service search condition may be specified as, for example,
service ID=“distribution batch service”
CPU use rate≦20%
necessary number=5

According to the route information accumulated in the route information DB 107, a search transfer unit 109 selects the server node 100 having no search record in the search history information added to the service search request message 114 when the search judgment unit 108 judges that non-matching. In this case, for example, the search transfer unit 109 selects the server node 100 having the highest priority in the route information. Then, the search transfer unit 109 transfers the service search request message 114 to which the information about the local server node 100 is added as search history information to the selected server node 100 through the message transmission unit 103.

A search result notification unit 110 performs the next process when the search judgment unit 108 judges the recognition of matching. The search result notification unit 110 notifies the requester of the service search request message 114 through the service search request message 114 a search result message 115 as a reply to the service search request message 114 according to the route information generated by the server node 100. The result of the search, the address (URI etc.) of the server which satisfies the condition is returned in the search result message 115. As a service search condition in the service search request message 114, the result of the search is received five times if, for example, 5 is set as the necessary number.

A service registration unit 111 registers or deletes the service information about the local server node 100 accumulated in the attribute information DB 101. A user may manually register a service through a human interface, or a service may be registered in batch processing (using an API or a command) etc. when the machine is activated.

A node information monitor unit 112 monitors the resources of the local server, and updates the service information and the resource information about the local server node 100 accumulated by the attribute information DB 101 based on the result of the monitoring.

With the above-mentioned configuration of the present embodiment, for example, the service search request message 114 from a client node is received by any server node 100 in a plurality of server nodes 100 connected over a network. When the received service search request message 114 is not processed in the local node, the service search request message 114 is transferred to another server node 100 determined based on the route information DB 107. If the service search request message 114 may be processed by the local node in any server node 100, a searching process is performed, and the result of the search is stored in the search result message 115, and transmitted to, for example, a client node as the requester of the service search request message 114. By the controlling operation, the load distribution may be performed without centrally searching for a particular node in a service search. According to the route information which is exchanged with one another, the optimum service execution node may be determined in the searching process.

Described below in detail is the operation of the present embodiment with the configuration illustrated in FIG. 1.

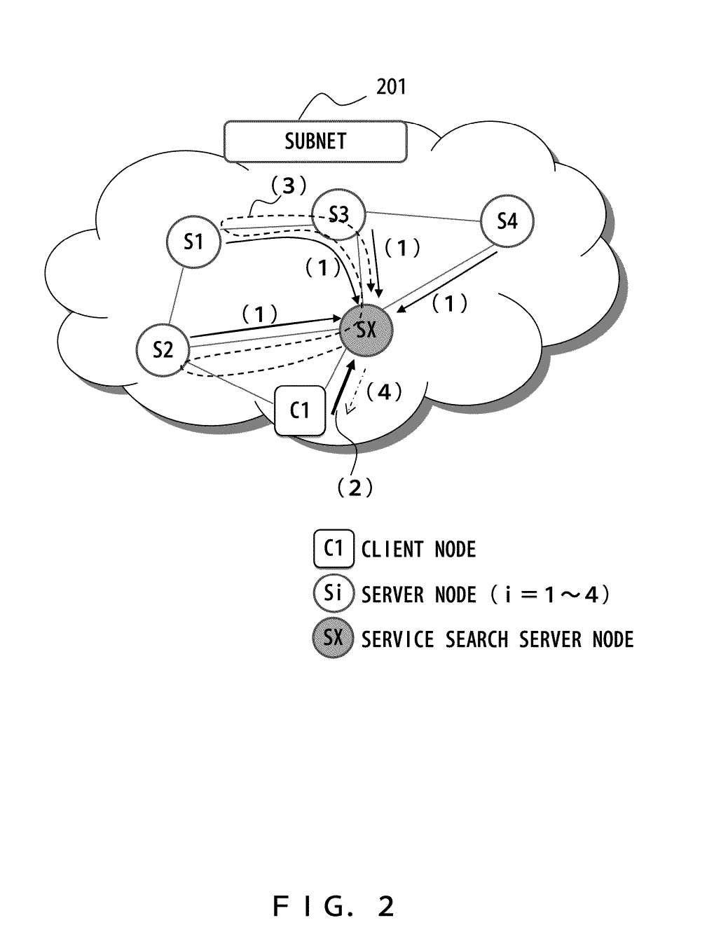

First, to compare with the present embodiment, an example of the conventional service search method is explained below with reference to FIG. 2. In FIG. 2, C1 indicates a client node, Si (i=1 through 4) indicates a server node, and SX indicates a service search server node. The configuration illustrated in FIG. 2 refers to a configuration in which each node is mutually connected in one subnet 201. The following processes (1) through (4) respectively correspond to the arrows of the processes (1) through (4).

In the system illustrated in FIG. 2, the service search server node SX which has received a search request from the client node C1 makes a search, and returns a result to the client node C1.

(1) The information (resource information, hard specification, service, etc.) of each server node is stored in the service search server node SX, and registered in a database.
(2) The service search server node SX receives a service search request from the client node C1
(3) The service search server node SX refers to the database of the local node, selects the server node Si corresponding to the request of the client node C1, and inquires whether or not request is acceptable. If the request is not acceptable, the database is referred to again, and the inquiry is continued until another selected server node Si returns a reply that the request is acceptable.
(4) The service search server node SX returns a result of the search to the client node C1.

In the configuration of the prior art which performs the controlling process (1) through (4) above, when the number of the client nodes which issue a search request increases in addition to the client node C1, the load of the service search server node SX which receives the search requests becomes heavy.

Then, in the present embodiment, the load distribution is realized by the server node 100 having the configuration illustrated in FIG. 1 performing the following distributed processing.

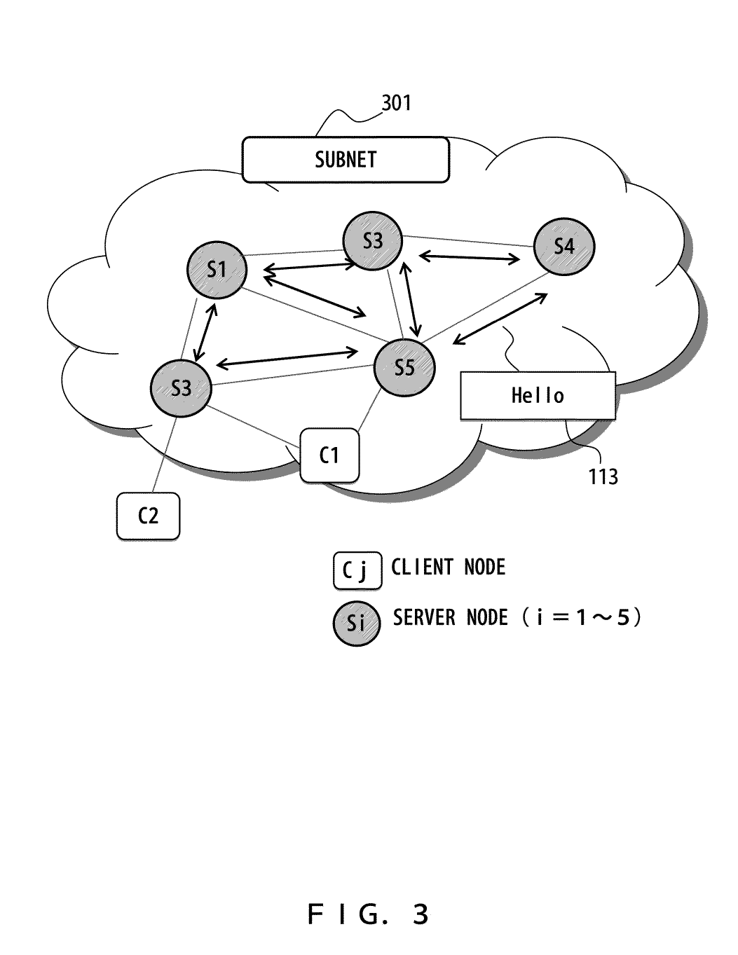

FIG. 3 is an explanatory view of the operation of exchanging attribute information according to the present embodiment having the configuration illustrated in FIG. 1. In FIG. 3, Cj (j=1, 2) indicates a server node, Si (i=1 through 5) indicates the server node 100 having the configuration illustrated in FIG. 1. The server node may be a virtual machine. With the configuration illustrated in FIG. 3, a number of server nodes Si are mutually connected in a subnet 301 which is a network which the Hello message 113 may reach. Furthermore, a client node Cj which uses any server node Si is connected to the server node Si from inside and outside the subnet 301. In the present embodiment, unlike the prior art, no particular service search server node SX illustrated in FIG. 2 is required.

With the configuration illustrated in FIG. 3, the route information notification unit 102 (illustrated in FIG. 1) in each server node Si uses the Hello message 113 indicated by the solid lines with bidirectional arrows illustrated in FIG. 3, and periodically broadcasts the attribute information read from the attribute information DB 101 in the local node to other server nodes Si. Otherwise, the Hello message 113 may be broadcast at the activation of the local node, at the generation of a particular event, etc.

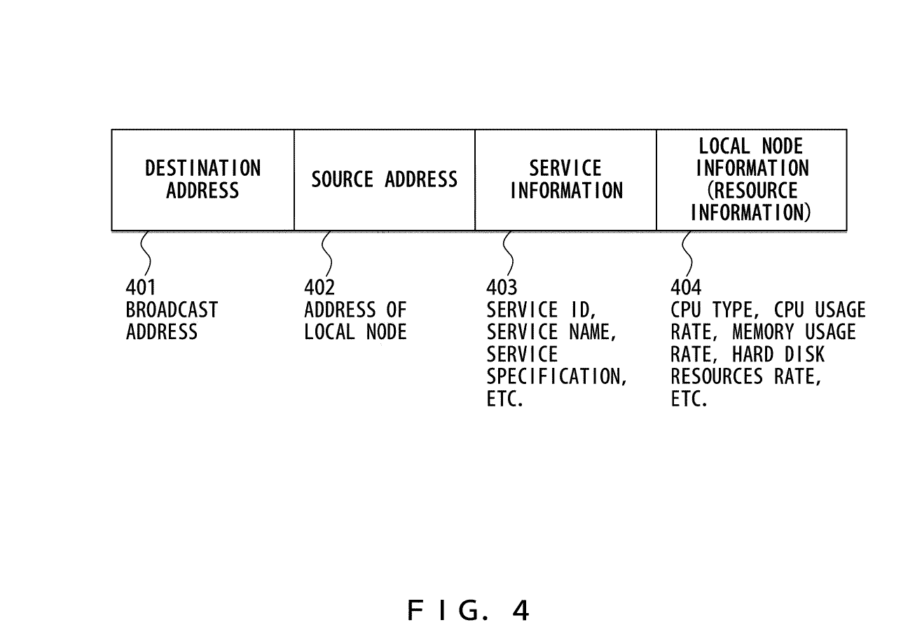

FIG. 4 is an example of a configuration of the data of the Hello message 113. As a destination address 401, the broadcast address in the subnet 301 (FIG. 3) is stored. As a source address 402, the address of the local node is stored. As service information 403, the service ID (identifier) of a service search, a service name, a service specification, etc. are stored. As local node information 404 as resource information, the resource information about the hardware of the server node 100 (Si) such as the CPU (central processing unit) type, the CPU usage rate, the memory usage rate, the hard disk usage rate, etc. is stored.

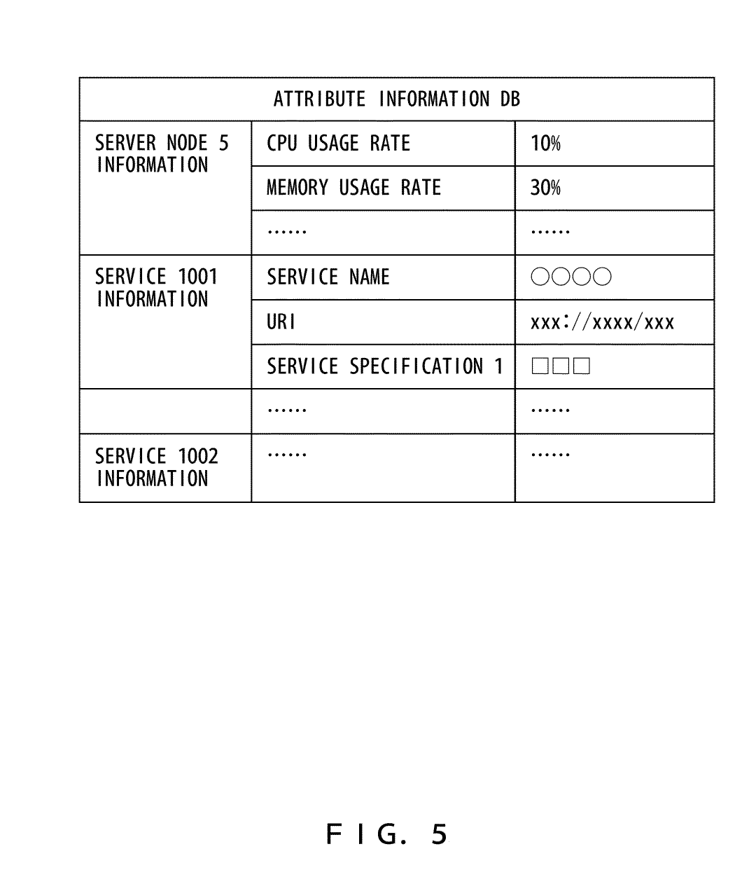

The service information and the resource information are acquired by referring to the attribute information DB 101 illustrated in FIG. 1. FIG. 5 is an example of a configuration of the data of the attribute information DB 101.

The attribute information DB 101 accumulates the CPU usage rate, the memory usage rate, etc. as the resource information as associated with the server node ID (identification information) (the server node 5 in FIG. 5) with respect to the server node 100. The resource information is monitored by the node information monitor unit 112 illustrated in FIG. 1, for example, periodically, at the activation, or at an occurrence of an event, and is updated based on the result of the monitoring. The monitoring is performed by executing a command to acquire a CPU usage rate, a memory usage rate, etc.

The attribute information DB 101 accumulates the following service information associated with the service ID (the description example of a service 1001 or service 1002) of the search service. They are the service name, the URI (uniform resource identifier), the service specification, etc. The service name is a character string. For example, an expression indicating a distributed file system, for example, hdfs_system:// . . . is set in the URI. The service specification is, for example, the capacity of a hard disk.

The route information notification unit 102 in FIG. 1 generates the Hello message 113 having the data configuration as exemplified in FIG. 4 by referring to the attribute information DB 101 having the configuration exemplified in FIG. 5, and broadcasts the message.

Back in FIG. 3, the route information generating unit 106 (FIG. 1) in each server node Si receives the Hello message 113 broadcast from another server node Si, generates the route information with a priority, and it in the route information DB 107 (FIG. 1) or updates the information.

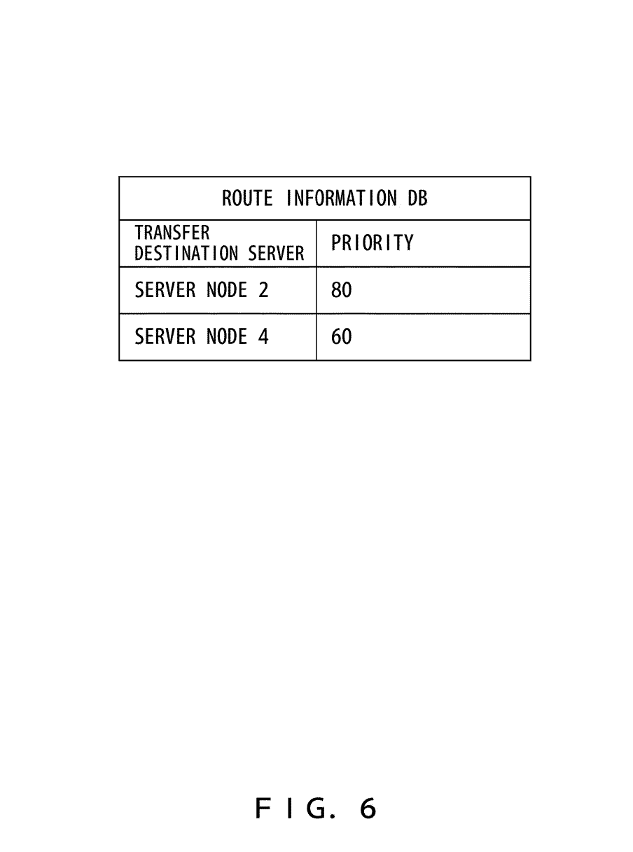

FIG. 6 is an example of a configuration of the data of the rout information DB 107. As route information, the server identification information about the destination server (the description examples “server node 2” of “server node 4” in FIG. 6) and the information about the priority corresponding to each piece of server identification information (the description examples 80 or 60 in FIG. 6) are registered. The server identification information may be, for example, the host name of the server node 100 or a destination address. The route information generating unit 106 in FIG. 1 determines the priority for each server node Si (FIG. 3) by, for example, a specified evaluation function. The evaluation function is defined using as a parameter the CPU type, the CPU usage rate, the memory usage rate, and the hard disk usage rate included in the local node information as the resource information in the Hello message 113 having the configuration exemplified in FIG. 4, and the load rate by the service included in the service information, etc. For example, the priority is higher with a lower CPU usage rate, etc. The method of determining the priority may be determined depending on the usage of each server node Si in the network.

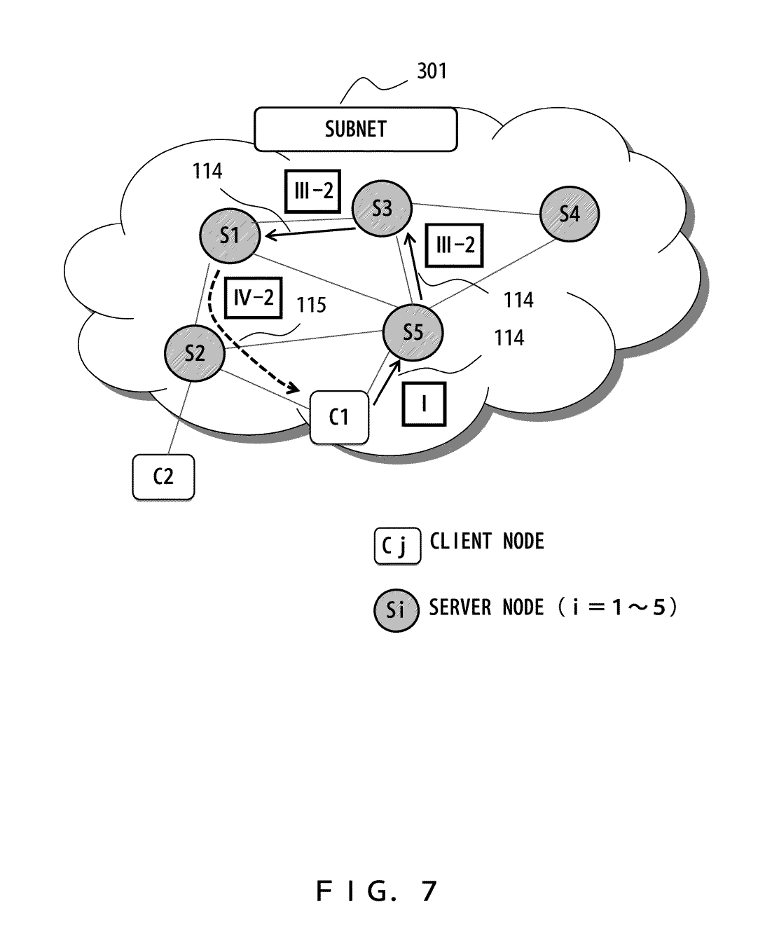

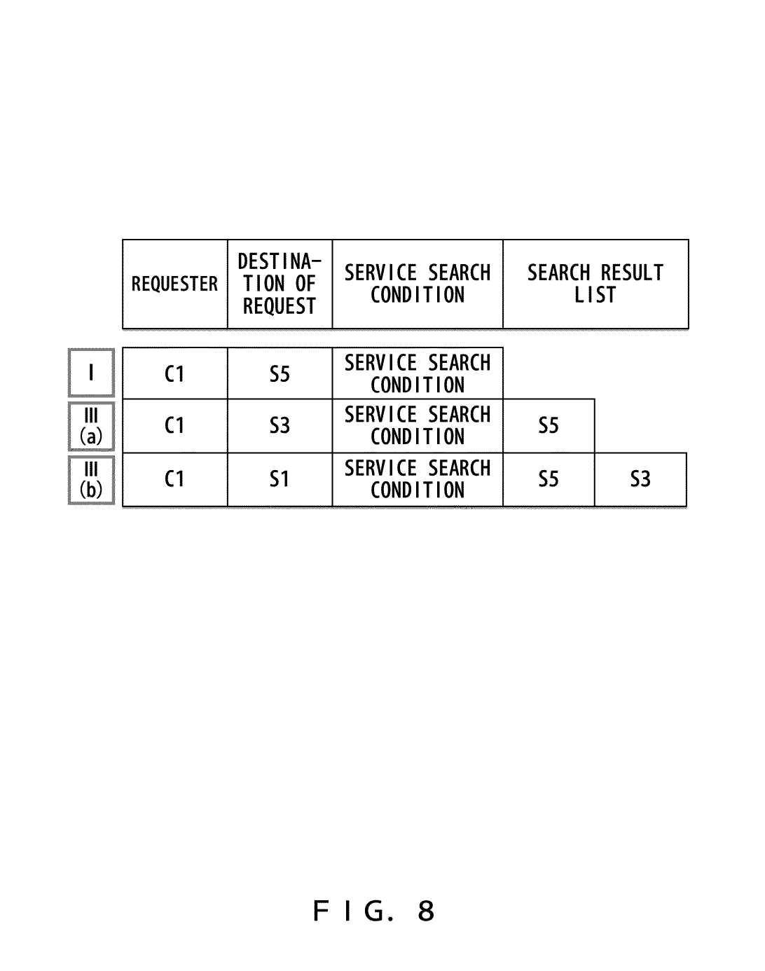

FIG. 7 is an explanatory view of the operation of transferring the service search request message 114 in FIG. 1 according to the present embodiment. In FIG. 7, the server node Si, the client node Cj, and the subnet 301 are similar to those illustrated in FIG. 3. In the following explanation, the configuration in FIG. 1 is referred to at any time. Each of the following processes I, II, III (III-1, III-2), and IV (IV-1, IV-2) indicates the process of the part assigned the same number enclosed by the square as illustrated in FIG. 7. FIG. 8 is an example of a configuration of the data of a service search request message. Each row of I, III(a), and III(b) in FIG. 8 indicates the data structure of the service search request message 114 used in each of the processes I and III below.

(I) The client node C1 transmits the service search request message 114 having the data structure expressed as I in FIG. 8 to an arbitrarily specified server node, for example, the server node S5. The arrow I directed from C1 to S5 in FIG. 7 corresponds to the process. As illustrated in FIG. 8, the service search request message 114 stores as a requester the address of the client node C1 (C1 as the description example of I in FIG. 8). The address of the server node S5 (S5 as the description example of I in FIG. 8) is stored as request destination. A specified service search condition is also stored.
(II) In the server node S5, upon receipt of the service search request message 114, the search judgment unit 108 refers to the attribute information DB 101 of the local node, thereby judging whether or not the service search condition in the service search request message 114 received by the local node is satisfied.
(III-1) When the result of the judgment by the search judgment unit 108 indicates NG (the condition is not satisfied), the search judgment unit 108 transfers the service search request message 114 to the search transfer unit 109.
(III-2) The search transfer unit 109 judges the destination server node by referring to the route information DB 107, stores the address of the server node (S3 as the description example of III(a) in FIG. 8) in the request destination of the service search request message 114, adds the local node ID (S5 as the description example of III (a) in FIG. 8) to the search result list as the search history information about the service search request message 114, and transfers the message to the server node (S3). The arrow III-2 directed from S5 to S3 in FIG. 7 corresponds to the process.

Hereafter, a similar process is performed in the destination.

(II) That is, in the server node S3, upon receipt of the service search request message 114, the search judgment unit 108 refers to the attribute information DB 101 of the local node, thereby judging whether or not the service search condition in the service search request message 114 received by the local node is satisfied.
(III-1) When the result of the judgment by the search judgment unit 108 indicates NG (the condition is not satisfied), the search judgment unit 108 transfers the service search request message 114 to the search transfer unit 109.
(III-2) The search transfer unit 109 judges the destination server node by referring to the route information DB 107, stores the address of the server node (S1 as the description example of III(b) in FIG. 8) in the request destination of the service search request message 114, adds the local node ID (S3 as the description example of III (b) in FIG. 8) to the search result list (search history information) about the service search request message 114, and transfers the message to the server node (S1). The arrow III-2 directed from S3 to S1 in FIG. 7 corresponds to the process.
(II) Also in the server node S1, upon receipt of the service search request message 114, the search judgment unit 108 refers to the attribute information DB 101 of the local node, thereby judging whether or not the service search condition in the service search request message 114 received by the local node is satisfied.
(IV-1) When the result of the judgment by the search judgment unit 108 is OK (the condition is satisfied), the service search request message 114 is transmitted to the search result notification unit 110.
(IV-2) The search result notification unit 110 generates the search result message 115 in which the result of the service search is stored, and transmits the message to the client node C1 as the requester. The arrow IV-2 directed to the client node C1 from the server node S1 through the server node S2 corresponds to the process.

According to the example of the operation illustrated in FIG. 7, for example, the service search request message 114 from the client node C1 is received by an arbitrary server node S5. When the received service search request message 114 is not processed in the local node, the message is transferred from the server node S5 to the server node S3, and then to the server node S1, and the searching process is performed in the server node S1. The result of the search is stores in the search result message 115 by the server node S1, and notified to, for example, the client node C1 as the source. After the above-mentioned controlling operation, the service search request message 114 from the client node Cj may be received by an arbitrary server node Si, and transferred to the server node Si in which the search may be performed. Thus, a load distribution may be performed without concentration on a particular node. According to the route information accumulated in advance in the route information DB 107, an appropriate service execution node may be determined during the searching operation.

Thus, under the service search condition stored in the service search request message 114, the configuration may be designed to specify a search in a plurality of server nodes Si. In this case, when the search judgment unit 108 judges the recognition of the matching, the search result notification unit 110 notifies the source of the service search request message 114 of the search result message 115, and performs the subsequent process. Unless the number of the servers specified by the service search condition is 1, the search result notification unit 110 decreases by one the number of server nodes Si specified by the service search condition in the service search request message 114, and then instructs the search transfer unit 109 to transfer the service search request message 114. With the above-mentioned configuration, the service searching process may be performed on the service search request message 114 using a plurality of server nodes Si with load distribution amount the plurality of server nodes Si.

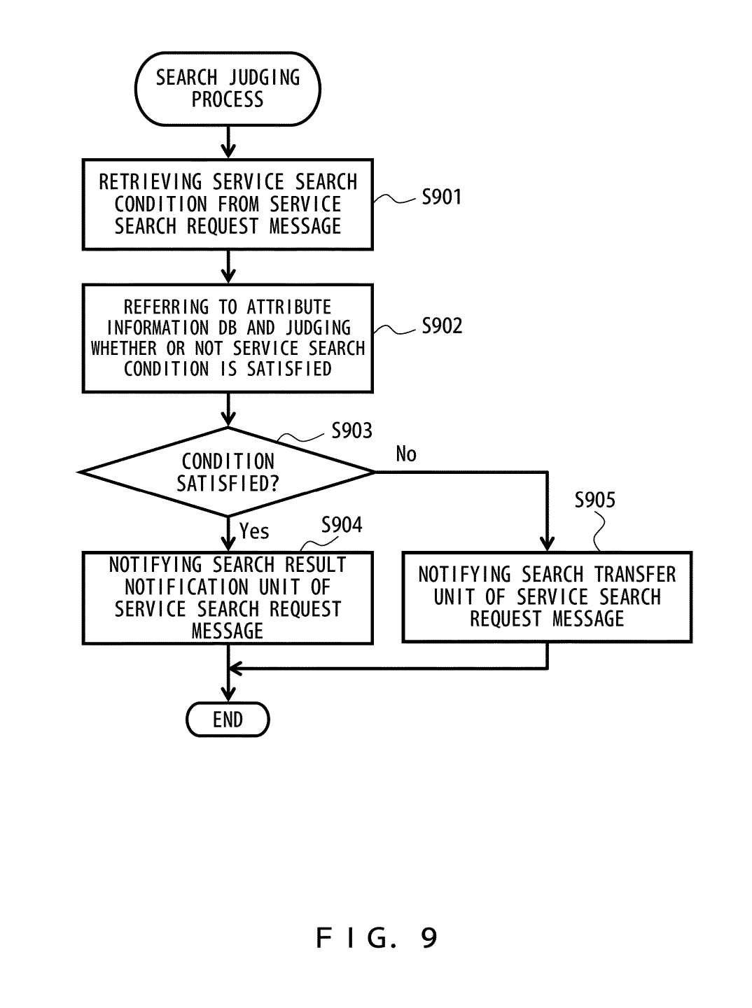

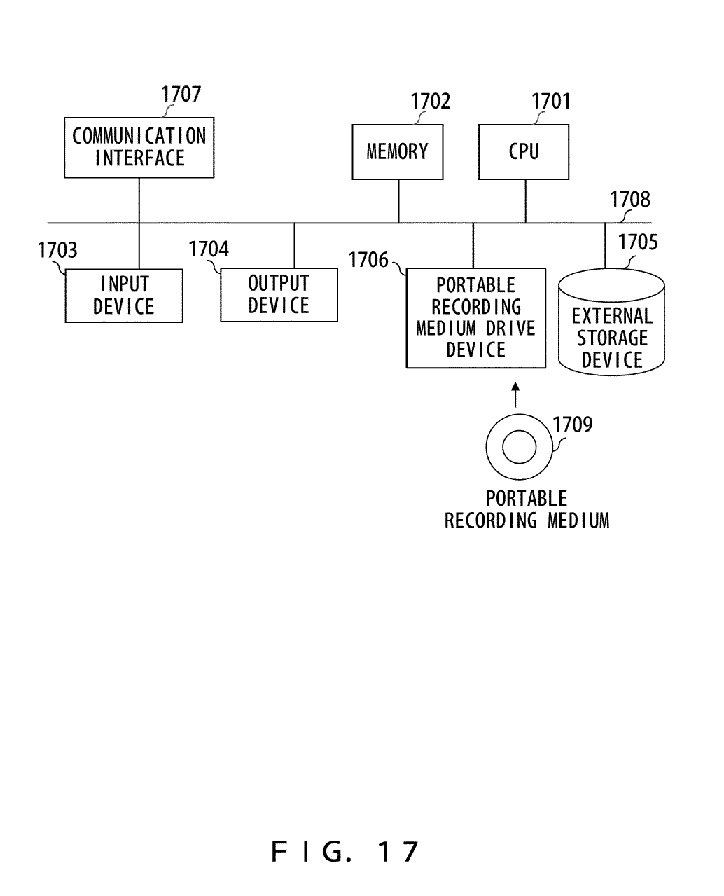

FIG. 9 is a flowchart of the search judging process of realizing the search judgment unit 108 in FIG. 1. The flowchart is realized as, for example, an operation of executing the control program stored in memory 1702 by a CPU 1701 described later and illustrated in FIG. 17.

First, the service search condition is retrieved from the service search request message 114 (step S901).

Next, the attribute information DB 101 in FIG. 1 is referred to, and it is judged whether or not the service search condition retrieved in step S901 is satisfied (step S902).

If the service search condition is satisfied (YES as the judgment in step S903), the service search request message 114 is notified to the search result notification unit 110 (step S904). Then, the control of the search judging process is terminated.

If the service search condition is not satisfied (NO as the judgment in step S903), the service search request message 114 is notified to the search transfer unit 109 (step S905). Then, the control of the search judging process is terminated.

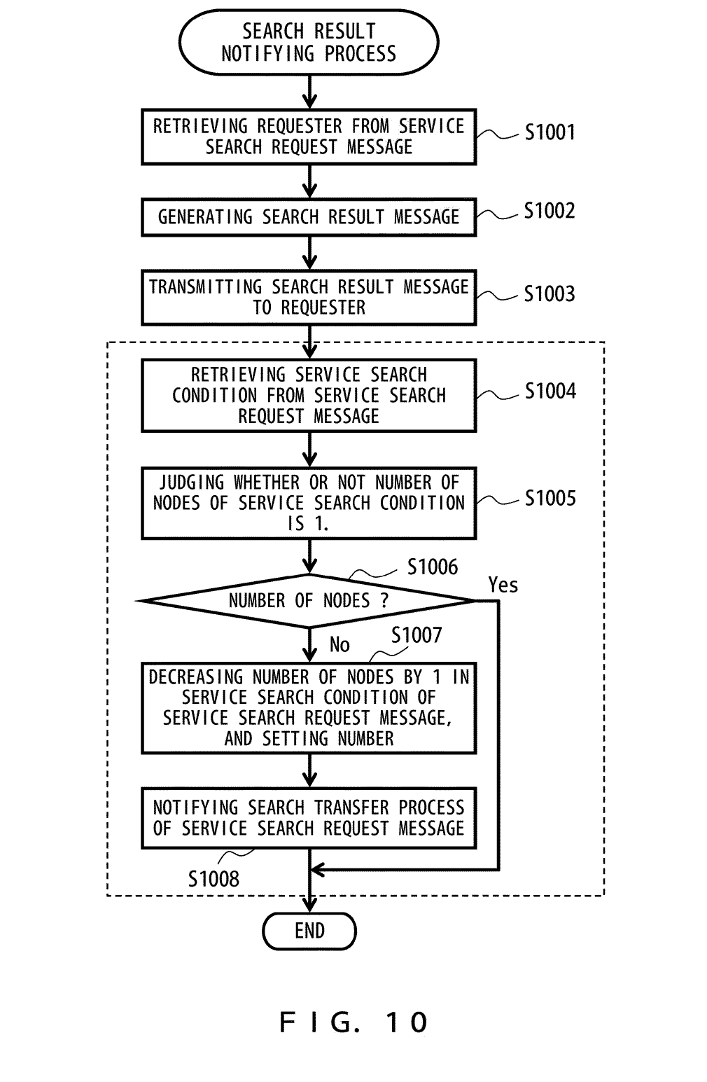

FIG. 10 is a flowchart of the search result notifying process for realizing the search result notification unit 110 in FIG. 1. The flowchart is realized as an operation of executing the control program stored in the memory 1702 by the CPU 1701 described later and illustrated in FIG. 17.

First, a requester is retrieved from the service search request message 114 (refer to FIG. 8) (step S1001).

Next, the search result message 115 in which the result of a search is stored and the requester retrieved in step S1001 is stored is generated (step S1002).

Next, the search result message 115 generated in step S1002 is transmitted to the requester (step S1003).

Unless the service search request message 114 specifies the search in a plurality of server node Si, the search result notifying process in FIG. 10 is terminated as is by terminating the process in step S1003.

On the other hand, if the search in the plurality of server nodes Si is specified in the service search condition stored in the service search request message 114, a series of processes from step S1004 to step S1008 indicated by the broken lines in FIG. 10 are performed.

First, the service search condition is retrieved from the service search request message 114 (step S1004).

Next, it is judged whether or not the number of nodes on the service search condition is 1 (step S1005).

If the number of nodes is 1 (YES as the judgment in step S1006), the search result notifying process in FIG. 10 is terminates as is.

Unless the number of nodes is 1 (NO as the judgment in step S1006), the number of server nodes Si specified in the service search condition in the service search request message 114 is decreased by one (step S1007).

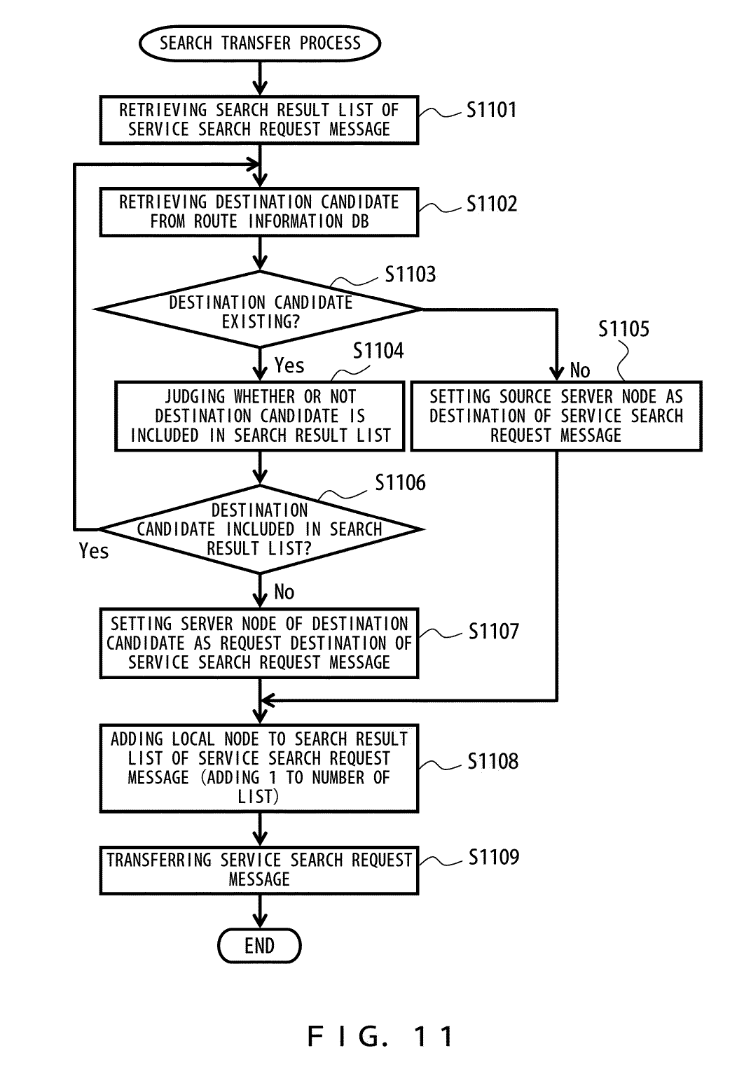

Then, the search transfer process described later with reference to FIG. 11 is activated, and the service search request message 114 is transferred (step S1008), thereby terminating the control of the search notifying process.

After returning the search result message 115 in step S1003, the service search request message 114 is further transferred to another server node Si to perform the searching process in the processes in steps S1004 through S1008.

FIG. 11 is a flowchart of the search transfer process for realizing the search transfer unit 109 in FIG. 1. The flowchart is realized as, for example, an operation of executing the control program stored in memory 1702 by a CPU 1701 described later and illustrated in FIG. 17.

First, the search result list (search history information) of the service search request message 114 (refer to FIG. 8) is retrieved (step S1101).

Next, a destination candidate is retrieved from the route information DB 107 in the order of a higher priority server node Si (step S1102).

It is judged whether or not there is a destination candidate (step S1103).

If there is a destination candidate, and the judgment in step S1103 is YES, then it is judged whether or not the destination candidate is included in the search result list (search history information) retrieved in step S1101 (step S1104).

If the destination candidate is included in the search result list, and the judgment in step S1106 is YES, then control is returned to step S1102, and the next destination candidate is retrieved from the route information DB 107.

If no destination candidate is included in the search result list and the judgment in step S1106 is NO in the loop process in steps S1102 through S1106, then the server node Si of the destination candidate is set in the request destination (refer to FIG. 8) of the service search request message 114 (step S1107).

On the other hand, if no destination candidate is included in the search result list and the judgment in step S1106 is NO in the loop process in steps S1102 through S1106, then the subsequent process is performed so that the service search request message 114 may be returned to the source server node (back track). The source server node (which is known from the search result list) is set as the request destination of the service search request message 114 (step S1105).

After the process in step S1107 or S1105, the local node is added to the search result list of the service search request message (1 is added to the number of list) (step S1108).

Finally, the service search request message 114 is transferred through the message transmission unit 103 (step S1109). Then, the control of the search transfer process is terminated.

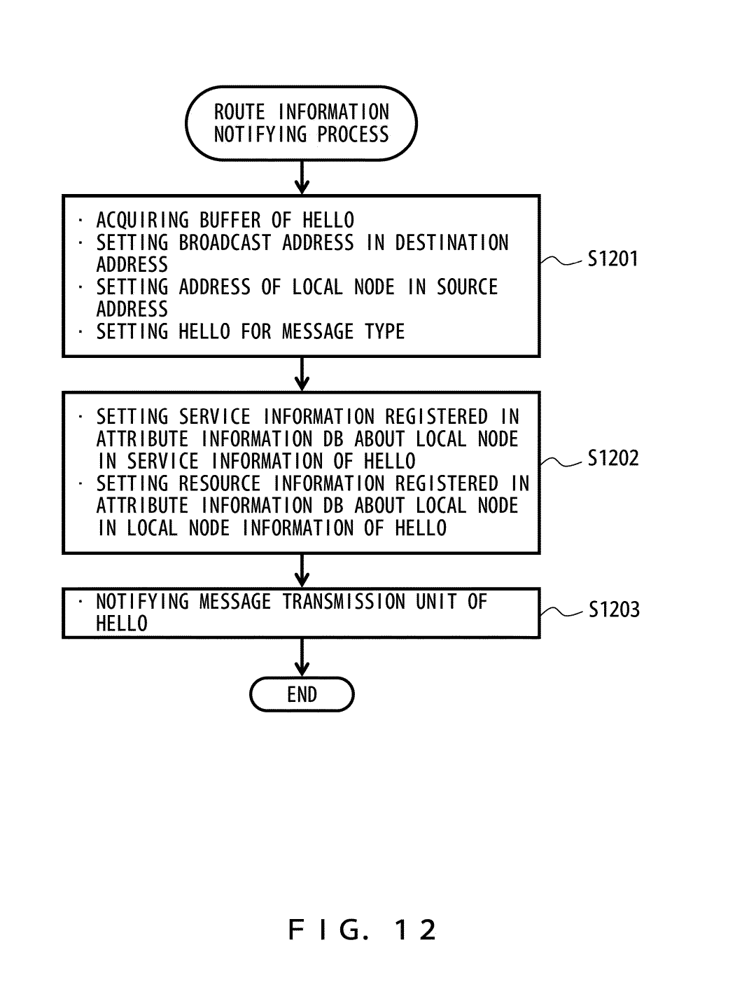

FIG. 12 is a flowchart of the route information notifying process for realizing the route information notification unit 102 in FIG. 1. The flowchart is realized as, for example, an operation of executing the control program stored in memory 1702 by a CPU 1701 described later and illustrated in FIG. 17.

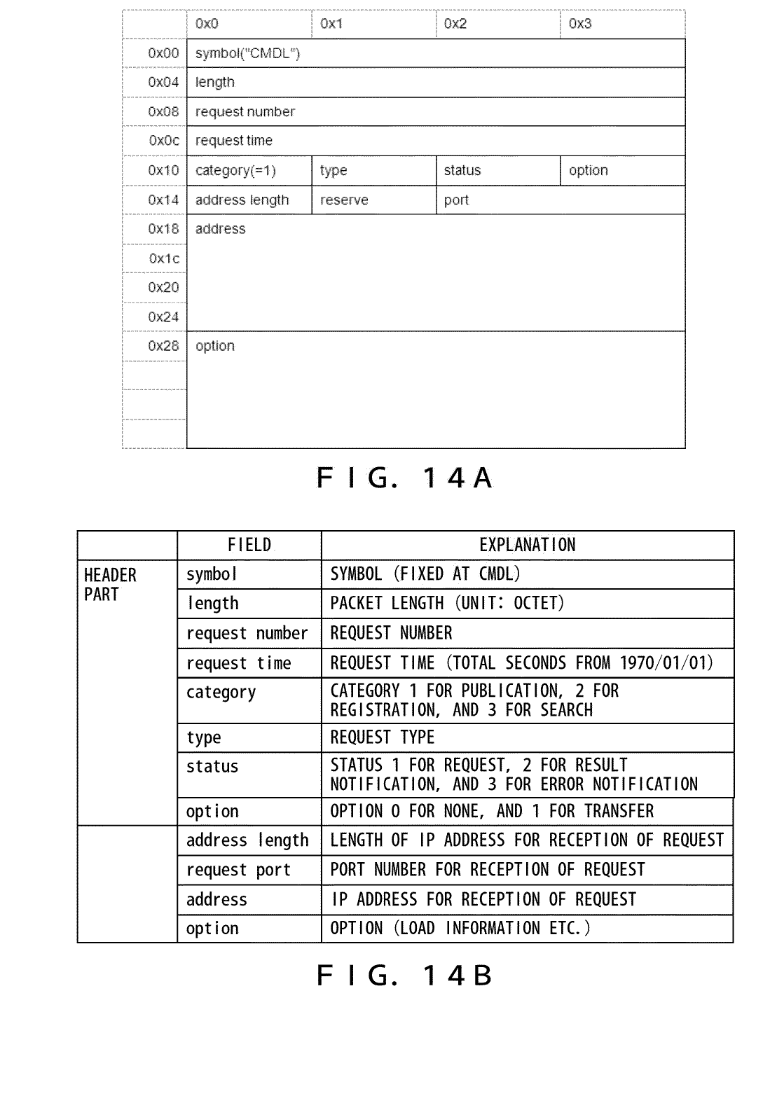

First, the buffer of the Hello message 113 is acquired. Then, the broadcast address is set in the destination address (401 in FIG. 4). Furthermore, the address of the local node is set in the source address (402 in FIG. 4), and “Hello” is set in the message type (type field illustrated in FIG. 14B and described later) (step S1201).

Next, the service information registered in the attribute information DB 101 of the local node is set in the service information (404 in FIG. 4) of the Hello message 113. Furthermore, the resource information registered in the attribute information DB 101 of the local node is set in the local node information (404 in FIG. 4) of the Hello message 113 (step S1202).

Then, the Hello message 113 generated in steps S1201 and S1202 is notified and transmitted to the message transmission unit 103 (step S1203), thereby terminating the route information notifying process in FIG. 12.

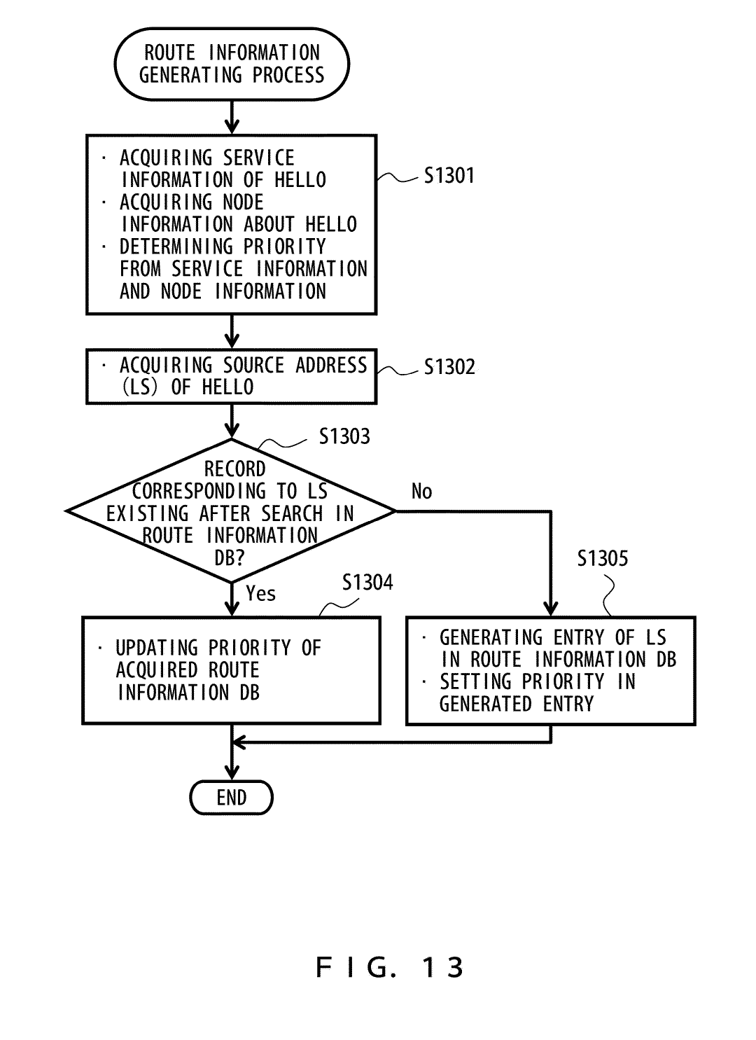

FIG. 13 is a flowchart of the route information generating process for realizing the route information generating unit 106 in FIG. 1. The flowchart is realized as, for example, an operation of executing the control program stored in memory 1702 by a CPU 1701 described later and illustrated in FIG. 17.

The service information (403 in FIG. 4) and the local node information (404 in FIG. 4) about the received Hello message 113 are acquired, and the priority is determined from the service information and the local node information as the resource information (step S1301).

Next, the source address (402 in FIG. 4) of the rd Hello message 113 is acquired (step S1302), and is hereafter referred to as an LS.

Next, the route information DB 107 is searched, and it is judged whether or not there is a request corresponding to the LS acquired in step S1202 (step S1303).

If the judgment in step S1303 is YES, then the priority of the acquired route information DB 107 is updated by the priority determined in step S1301 (step S1304), thereby terminating the route information generating process in FIG. 13.

If the judgment in step S1303 is NO, an entry of the LS acquired in step S1302 is generated in the route information DB 107, and the priority determined in step S1301 is set in the generated entry (step S1305), thereby terminating the route information generating process.

FIGS. 14A and 14B are an example of a data format of the Hello message 113.

Each of the fields “symbol”, “length”, “request number”, “request time”, “category”, “type”, “status”, and “option” configures the header part of the Hello message 113. In the fields, especially the type field stores the value indicating the Hello message 113 as the type of message.

“Address length” indicates the length of the IP (Internet protocol) address for reception of a request. “Request port” indicates the port number for reception of a request. “Address” indicates the IP address for reception of a request. “Option” indicates an option field, and stores the service information 403, the local node information (resource information) 404, etc. in FIG. 4.

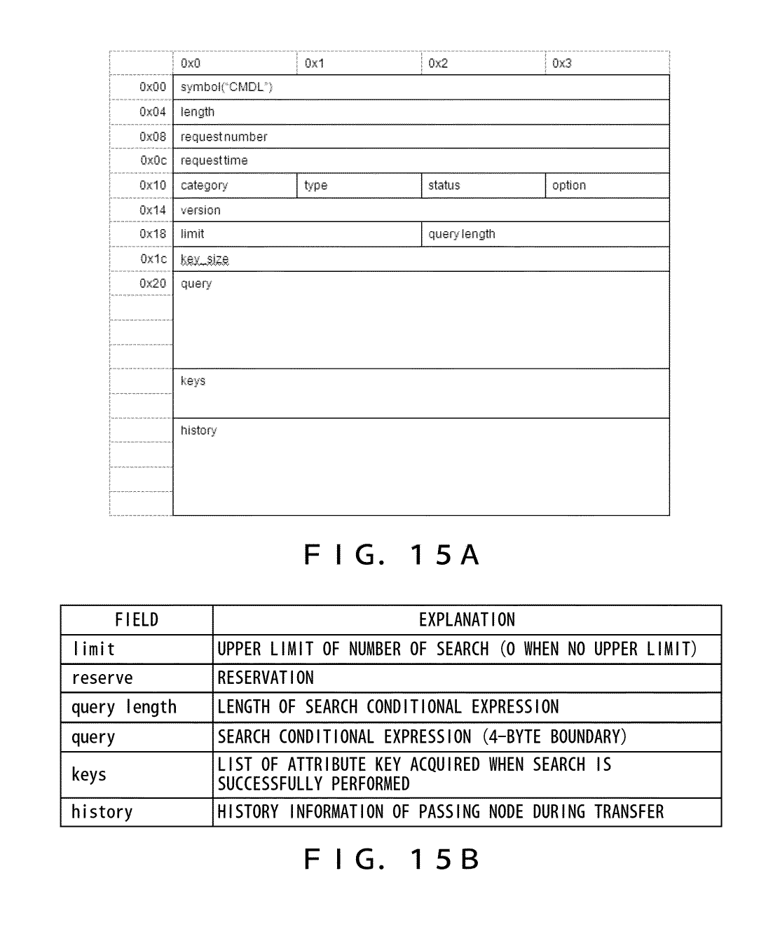

FIGS. 15A and 15B are an example of a data format of the service search request message 114.

The header part of the service search request message 114 is the same as the header part of the Hello message 113 illustrated in FIG. 14B. In this case, the type field stores the value indicating the service search request message 114 as the type of message.

The upper limit of the number of searches is set in “limit”. When no upper limit is set, 0 is set. “Reserve” is a reservation field. “Query length” stores the length of the conditional expression of a service search condition. “Query” stores the conditional expression of the service search condition with the 4-byte boundary. “Keys” stores a list of the attribute keys acquired when a search is successfully performed. “History” stores history information about a passing node during the transfer, that is, a search result list (search history information).

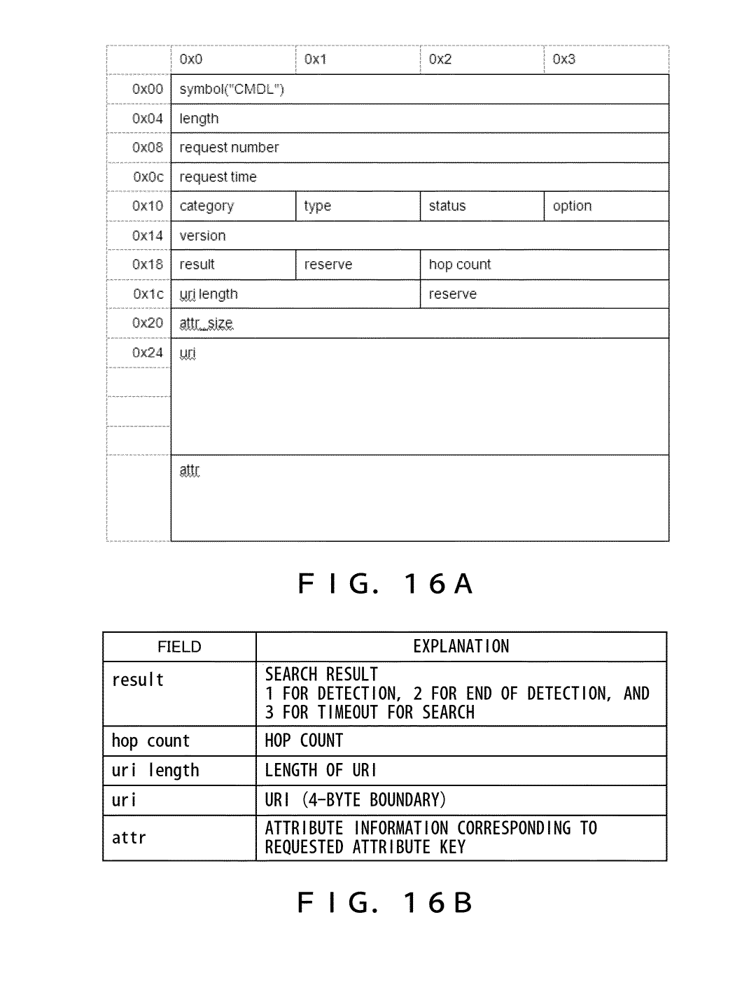

FIGS. 16A and 16B are an example of a data format of the search result message 115.

The header part of the search result message 115 is the same as the header part of the Hello message 113 illustrated in FIG. 14B. In this case, the type field stores the value indicating the search result message 115 as a type of message.

“Result” stores the result of a search (1 as detection, 1 as completion of search, and 3 as detection timeout). “Hop count” stores the number of hops. “Uri length” stores the length of the URI. “Uri” stores the URI indicating the location of the result of a search with the 4-byte boundary. “Attr” stores the attribute information corresponding to the requested attribute key.

FIG. 17 is a configuration of a hardware system capable of realizing the system according to the present embodiment.

FIG. 17 is an example of a configuration of the hardware of the computer capable of realizing the system above by software processing.

The computer illustrated in FIG. 17 includes a CPU 1701, memory 1702, an input device 1703, an output device 1704, an external storage device 1705, a portable recording medium drive device 1706 into which a portable recording medium 1709 is inserted, and a communication interface 1707. These components are mutually connected through a bus 1708. The configuration illustrated in FIG. 17 is an example of a computer capable of realizing the above-mentioned system, and the computer is not limited to the configuration.

The CPU 1701 controls the entire computer. The memory 1702 such as RAM etc. temporarily stores a program or data stored in the external storage device 1705 (or portable recording medium 1709) when data is updated etc. The CPU 1701 controls the entire computer by reading the program to the memory 1702 and executing the program.

The input and the output devices 1703 and 1704 detect the input operation by a user using a keyboard, a mouse, etc., and notify the CPU 1701 of the result of the detection, and outputs the data transmitted by the control of the CPU 1701 on a display device and a printer.

The external storage device 1705 is, for example, a hard disk storage device, and mainly used in storing various data and programs.

The portable recording medium drive device 1706 accommodates a portable recording medium 1709 such as an optical disk, SDRAM, CompactFlash, etc., and functions as an accessory to the external storage device 1705.

The communication interface 1707 is, for example, a device for connecting a communication line of a LAN (local area network) or a WAN (wide area network).

The system according to the present embodiment is realized by executing by the CPU 1701 a program loaded with each function illustrated in FIG. 1, or a function realized by the flowchart etc. illustrated in FIGS. 9 through 13. The program may be distributed by recording in the external storage device 1705 and the portable recording medium 1709, or may be acquired from a network by the communication interface 1707.

All examples and conditional language provided herein are intended for the pedagogical purposes of aiding the reader in understanding the invention and the concepts contributed by the inventor to further the art, and are to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A service search method using a plurality of servers which perform services in distributed processing, the method comprising:
generating route information by switching attribute information about a server with other servers;
judging when receiving a service search request from a service search requester whether or not a local server matches a service search condition stored in the service search request by referring to attribute information about the local server;
selecting according to the route information a server having no search record in search history information which is added to the service search request when it is judged that the local server does not match the service search condition;
transferring to the selected server the service search request to which the information about the local server is added as the search history information; and
notifying a service search requester of a search request reply according to the route information generated by the local server when it is judged that the local server matches the service search condition.

2. The method according to claim 1, wherein:
when the route information is generated, a priority of service search calculated according to the switched attribute information is added to the route information; and
when the service search request is transferred, a server of a higher priority included in the route information is selected.

3. The method according to claim 1, further comprising:
specifying a search in a plurality of servers in the service search condition stored in the service search request; and
selecting a server having no search record in search history information stored in the service search request according to the route information unless a number of servers specified by the service search condition is 1 when it is judged that the matching is recognized, decreasing by 1 the number of servers specified by the service search condition, and transferring to the selected server the service search request to which the information about the local server is added as search history information.

4. The method according to claim 1, further comprising:
including service information and resource information in the attribute information;
registering or deleting the service information; and
monitoring resources of the local server, and updating the resource information based on a result of the monitoring.

5. A non-transitory computer-readable recording medium having stored therein a program for causing a computer to allow a plurality of servers which perform services in distributed processing to execute a process comprising:
generating route information by switching attribute information about a server with other servers;
judging when receiving a service search request from a service search requester whether or not a local server matches a service search condition stored in the service search request by referring to attribute information about the local server;
selecting according to the route information a server having no search record in search history information which is added to the service search request when it is judged that the local server does not match the service search condition;
transferring to the selected server the service search request to which the information about the local server is added as the search history information; and
notifying a service search requester of a search request reply according to the route information generated by the local server when it is judged that the local server matches the service search condition.

6. The medium according to claim 5, the process further comprising:
when the route information is generated, adding a priority of service search calculated according to the switched attribute information to the route information; and
when the service search request is transferred, selecting a server of a higher priority included in the route information.

7. The medium according to claim 5, the process further comprising:
specifying a search in a plurality of servers in the service search condition stored in the service search request; and
selecting a server having no search record in search history information stored in the service search request according to the route information unless a number of servers specified by the service search condition is 1 when it is judged that the matching is recognized, decreasing by 1 the number of servers specified by the service search condition, and transferring to the selected server the service search request to which the information about the local server is added as search history information.

8. The medium according to claim 5, the process further comprising:
registering or deleting the service information; and
monitoring resources of the local server, and updating the resource information based on a result of the monitoring.

9. A plurality of server devices which performs a service, each of the plurality of server devices comprising:
a processor that performs a process including:
a route information generating unit configured to generate route information by switching attribute information about a server with other servers;
a search judgment unit configured to judge when receiving a service search request from a service search requester whether or not a local server matches a service search condition stored in the service search request by referring to attribute information about the local server;
a search transfer unit configured to select according to the route information a server having no search record in search history information which is added to the service search request when it is judged that the local server does not match the service search condition, and transferring to the selected server the service search request to which the information about the local server is added as the search history information; and
a search result notification unit configured to notify a service search requester of a search request reply according to the route information generated by the local server when it is judged that the local server matches the service search condition.

10. The each of the plurality of server devices according to claim 9, wherein:
when the route information is generated, the route information generating unit adds a priority of service search calculated according to the switched attribute information to the route information; and
when the service search request is transferred, the search transfer unit selects a server of a higher priority included in the route information.

11. The each of the plurality of server devices according to claim 9, wherein:
a search in a plurality of servers in the service search condition stored in the service search request is specified; and
when it is judged that the matching is recognized, the search result notification unit decreases the number of servers specified in the service search condition in the service search request by one unless the number of servers specified in the service search condition is 1, and instructs the search transfer unit to transfer the service search request.

12. The each of the plurality of server device according to claim 9, further comprising:
a service registration unit configured to register or delete the service information; and
a node information monitor unit configured to monitor resources of the local server and updates the resource information based on a result of the monitoring.
